(19) United States
(12) Patent Application Publication
(10) Pub. No.: US 2009/0080492 A1
(43) Pub. Date: Mar. 26, 2009

(54) Temperature sensor for internal combustion engine

(75) Inventor: Hisayuki Takeuchi, Obu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/232,479

(22) Filed: Sep. 18, 2008

(30) Foreign Application Priority Data
Sep. 20, 2007 (JP) 2007-243720

(51) Int. Cl. G01K 1/14

(52) U.S. Cl. 374/144; 374/E01.018

(57) ABSTRACT

A misfire in a combustion chamber of an internal combustion engine is detected by measuring a combustion chamber temperature with a temperature sensor element without using a pressure sensor having a low heat-resistive property. A temperature sensor includes an elongated probe portion extending from a housing. The housing is mounted on an engine so that the probe portion is exposed to the combustion chamber. A diaphragm is disposed on a tip of the probe portion, and a sensor element such as a thin film thermistor is mounted on the diaphragm, preferably on a rear surface of the diaphragm where the sensor element is not directly exposed to mixture gas in the combustion chamber. The sensor element may be embedded in the diaphragm. The probe portion of the temperature sensor may be integrally formed in a spark plug thereby to save a space for mounting the temperature sensor on the engine.

### CROSS-REFERENCE TO RELATED APPLICATION

This application is based upon and claims benefit of priority of Japanese Patent Application No. 2007-243720 filed on Sep. 20, 2007, the content of which is incorporated herein by reference.

### BACKGROUND OF THE INVENTION

1. Field of the Invention

The present invention relates to a temperature sensor for detecting temperature in a combustion chamber of an internal combustion engine.

2. Description of Related Art

In a system for controlling operation of an internal combustion engine, an electronic control unit (ECU) controls engine operation to optimum conditions based on signals fed from various sensors. A misfire in a combustion chamber is detected, as one of such signals, by a pressure sensor for detecting pressure in the combustion chamber. An example of the misfire detection based on the pressure in the combustion chamber is disclosed in JP-A-2005-326336.

The pressure sensor disclosed therein is composed of a housing mounted on a cylinder of an internal combustion engine, an elongated pipe extending from the housing, a diaphragm connected to the elongated pipe for directly receiving pressure in a combustion chamber, and a pressure-sensitive element mounted on a rear surface of the diaphragm. The rear surface means a surface which is opposite to a front surface of the diaphragm exposed to the combustion chamber. As shown in FIG. 7 attached hereto, the pressure P in the combustion chamber changes as shown with a solid line when mixture gas in the combustion chamber is normally ignited. On the other hand, the pressure P changes as shown with a dotted line when a misfire occurred. Therefore, whether a misfire occurred or not is detected by measuring the combustion chamber pressure P after a top dead center and by comparing the detected pressure P with a reference pressure. For example, the combustion chamber pressure P is measured at a crankshaft angle α is 5-10 degrees after the top dead center.

However, a following problem is involved in the pressure sensor disclosed in JP-A-2005-326336. Temperature in the combustion chamber becomes very high when the mixture is fired and exploded, for example, 2000-3000° C. The pressure-sensitive element used in the pressure sensor has a relatively low durability at a high temperature. Accordingly, an accuracy of the detected pressure tends to become low. For protecting the pressure-sensitive element from a high temperature, it is required to provide a temperature-resistive structure for the pressure-sensitive element. This makes the pressure sensor complex and expensive.

### SUMMARY OF THE INVENTION

The present invention has been made in view of the above-mentioned problem, and an object of the present invention is to provide a temperature sensor for an internal combustion engine for efficiently detecting a misfire in a combustion chamber.

The temperature sensor according to the present invention includes a housing mounted on a cylinder head or a cylinder block of an internal combustion engine. An elongated cylindrical probe portion is connected to the housing so that the probe portion extends into a combustion chamber of the engine. A diaphragm is disposed on a tip of the probe portion so that the diaphragm is exposed to the combustion chamber. A sensor element for measuring temperature in the combustion chamber is mounted on a rear surface, which is opposite to a front surface exposed to the combustion chamber, of the diaphragm. A conductor member for electrically connecting the sensor element to an outside circuit is led out through an inner space of the probe portion and a connector portion coupled to the housing.

The combustion chamber temperature becomes maximum after 5-10 degrees after a top dead center when an air-fuel mixture is successfully ignited, while it does not reach the maximum level when a misfire occurs. By measuring the combustion chamber temperature at a certain degree (e.g., 5-10 degrees) after the top dead center and comparing the detected temperature with a reference temperature, whether a misfire occurred or not is easily detected.

The sensor element may be mounted on a rear surface of a front surface of the diaphragm, or it may be embedded in the diaphragm. The probe portion having the diaphragm and the sensor element may be integrally formed in a spar plug to thereby save a space for the temperature sensor. The sensor element may be composed of a thin film thermistor or a thermocouple coated with a heat-resistive material.

According to the present invention, the misfire in the combustion chamber is surely detected by measuring the combustion chamber temperature with a temperature sensor having a high heat-resistivity without using a pressure sensor having a low heat-resistivity. Other objects and features of the present invention will become more readily apparent from a better understanding of the preferred embodiments described below with reference to the following drawings.

### BRIEF DESCRIPTION OF THE DRAWINGS

FIG. 1 is a cross-sectional view showing a temperature sensor for an internal combustion engine as a first embodiment of the present invention;

FIG. 2 is a cross-sectional view partially showing the temperature sensor shown in FIG. 1 in an enlarged scale;

FIG. 3 is a cross-sectional view showing a relevant portion of an internal combustion engine, where the temperature sensor is mounted;

FIG. 4 is a cross-sectional view partially showing a temperature sensor as a second embodiment of the present invention;

FIG. 5 is a cross-sectional view partially showing a temperature sensor as a third embodiment of the present invention;

FIG. 6 is a cross-sectional view partially showing a temperature sensor integrally formed with a spark plug as a fourth embodiment of the present invention; and

FIG. 7 is a graph showing a relation between a combustion chamber pressure P and a crank angle α of a crankshaft.

### DETAILED DESCRIPTION OF THE PREFERRED EMBODIMENTS

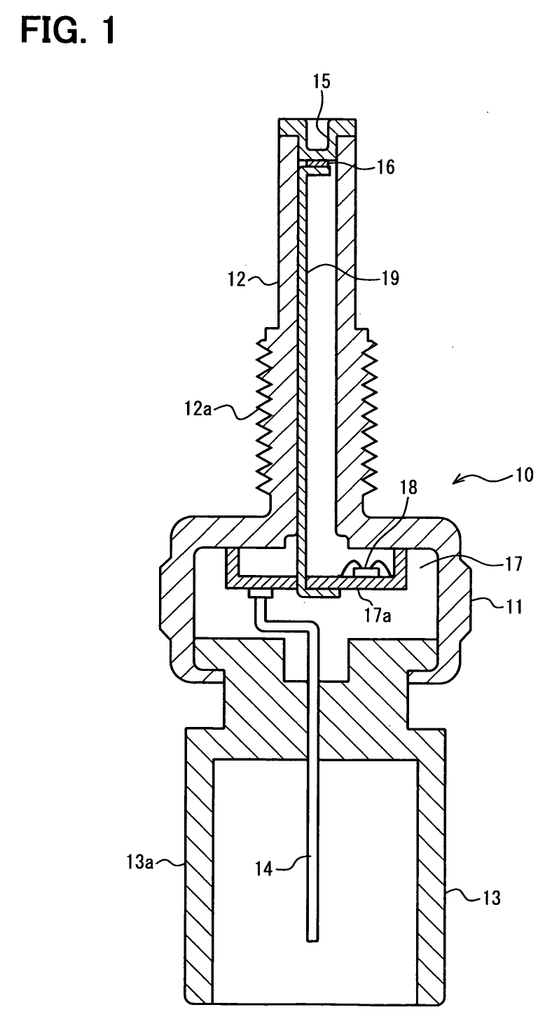

A first embodiment of the present invention will be described with reference to FIGS. 1-3. First, referring to FIG. 3, a combustion chamber of an internal combustion engine, where a temperature sensor 10 of the present invention is installed, will be briefly explained. The combustion chamber 1 is formed by a cylinder block 2 and a cylinder head 3. A piston 4 is disposed in a cylinder and reciprocally moves back and forth in the cylinder. An intake valve 5 and an exhaust valve 6 are disposed at an upper portion of the combustion chamber 1. A spark plug 7 for igniting mixture gas introduced into the cylinder is also provided at an upper portion of the combustion chamber 1. A temperature sensor 10 according to the present invention is installed in a mounting hole 8 formed in the cylinder block 2. The temperature sensor 10 may be installed in the cylinder head 3. Signals from the temperature sensor 10 are fed to an electronic control unit (ECU) 9 for detecting a misfire in the combustion chamber 1.

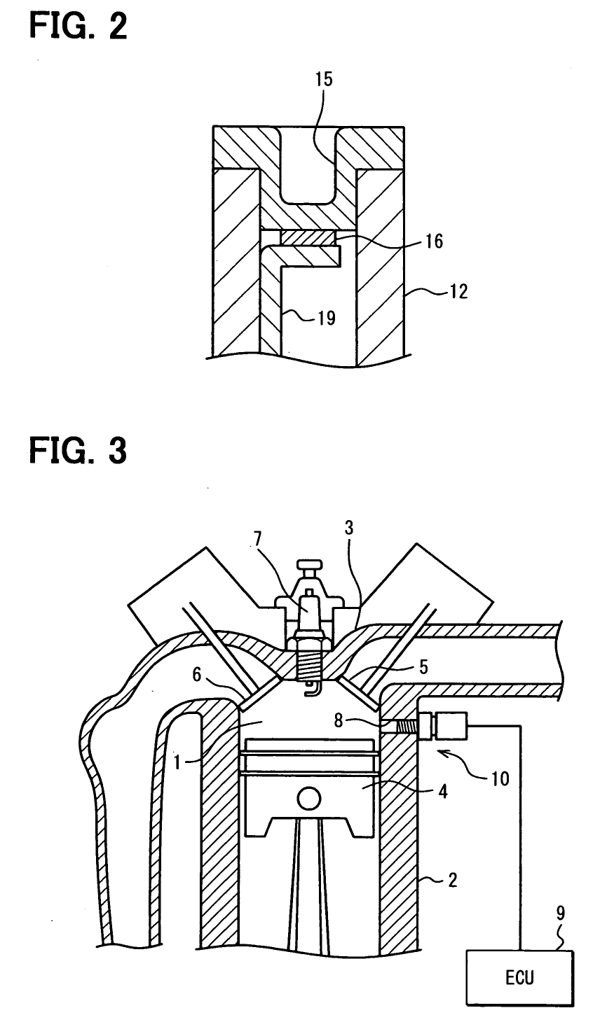

Now, the temperature sensor 10 will be described with reference to FIGS. 1 and 2. As shown in FIG. 1, the temperature sensor 10 includes a housing 11, a probe portion 12 extending from the housing 11 and a connector portion 13 fixed to the housing 11. The housing 11 is made of a metallic material such as SUS (stainless steel) in a cup shape having an open bottom end. The probe portion 12 is integrally formed with the housing 11 in an elongated pipe shape having an inner space. The connector portion 13 is fixed to the open bottom end of the housing 11 by staking or the like. The connector portion 13 includes a connector housing 13a made of a material such as synthetic resin and contains therein a terminal 14 for electrically connecting the temperature sensor 10 to the ECU 9. The terminal 14 maybe insert-molded in the connector housing 13a.

The probe portion 12 has a screw 12a that is screwed into a female-crew formed in the mounting hole 8 to thereby mount the temperature sensor 10 on the cylinder block 2. A diaphragm 15 is connected to the tip of the probe portion 12 by welding or the like so that it is exposed to the combustion chamber 1 when the temperature sensor 10 is mounted on the engine. The diaphragm 15 is made of a metallic material such as SUS (stainless steel) into a cup shape having an upper opening, as shown in FIGS. 1 and 2. A sensor element 16 for detecting temperature in the combustion chamber 1 is connected to a rear surface of the diaphragm 15 with adhesive or the like. The rear surface of the diaphragm is a surface opposite to another surface of the diaphragm that is exposed to the combustion chamber 1. The sensor element 16 is composed of a thin film thermistor in this embodiment.

As shown in FIG. 1, a signal-processing circuit 17 is disposed in the housing 11. The signal-processing circuit 17 is composed of a ceramic substrate 17a connected to the housing 11 and an IC-chip (an integrated circuit chip) 18 mounted on the ceramic substrate 17a. The sensor element 16 is electrically connected to the signal-processing circuit 17 through a conductor member 19 led through the inner space of the probe portion 12. The conductor member 19 is composed of, e.g., a conductor pattern formed on a flexible substrate. The terminal 14 is connected to a terminal formed on the ceramic substrate 17a by soldering.

The temperature sensor 10 described above is installed in the cylinder block 2 by fastening the screw 12a to the female screw formed in the mounting hole 8, so that the tip of the probe portion 12 is exposed to the combustion chamber 1. Signals outputted from the sensor element 16 and processed in the signal-processing circuit 17 are fed to the ECU 9 through the terminal 14 disposed in the connector portion 13. The temperature sensor 10 is installed to each cylinder of the multi-cylinder engine.

Advantages attained in the temperature sensor described above will be summarized. Temperature in the combustion chamber is detected by the sensor element 16 attached to the rear surface of the metallic diaphragm 15 with a high response. The temperature in the combustion chamber reaches to a high level, e.g., 2000-3000° C. Since the sensor element 16 for detecting the temperature has a sufficiently high heat-resistivity compared with the pressure sensor element used in the conventional pressure sensor, the sensor element 16 is not much affected by the high temperature, and combustion chamber temperature is accurately detected.

Since the sensor element 16 is attached to the rear surface of the diaphragm 15, the sensor element 16 is not directly exposed to the mixture at a high temperature in the combustion chamber. Since the inner space of the probe portion 12 is closed with the diaphragm 15, the mixture at a high temperature and high pressure does not enter into the inner space of the probe portion 12. Only the conductor element 19 and the sensor element 16 are disposed in the inner space which becomes at a high temperature, while the signal-processing circuit 17 including the IC-chip 18 which has a relatively low heat-resistivity is disposed inside the housing 11 which is kept at a relatively low temperature. Therefore, the components of the temperature sensor are well protected from the high temperature without providing a complex heat-insulating structure.

The ECU 9 controls operation of the engine based on signals fed from various sensors including the temperature sensor 10. The ECU determines whether a misfire occurred or not in the combustion chamber 1 based on the signal from the temperature sensor 10. As shown in FIG. 7, the combustion chamber pressure P varies according to the crankshaft angle α(t). If no misfire occurs the combustion chamber pressure P varies as shown with a solid line, while it varies as shown with a dotted line if a misfire occurs. Therefore, whether the misfire occurred or not can be determined based on the combustion chamber pressure P detected after the top dead center, e.g., 5-10° crankshaft angle after the top dead center (α=0). The detected combustion chamber pressure P is compared with a predetermined reference value.

In the present invention, in place of directly measuring the combustion chamber pressure P, the temperature in the combustion chamber is detected by the temperature sensor 10. The combustion chamber pressure P is indirectly detected based on the temperature in the combustion chamber. A relation between the pressure P and the temperature T is expressed in the formula: PV=nRT, where V is a volume of the combustion chamber at a given crankshaft angle α. This means that PV/T is constant. Since the combustion chamber volume V is a known value at a given crankshaft angle, the combustion chamber pressure P can be calculated from the detected temperature T in the combustion chamber. Accordingly, the misfire can be easily determined based on the combustion chamber temperature T. Since the temperature sensor 10 is mounted on each cylinder of the engine, the misfire occurred in each cylinder is accurately detected by the ECU 9.

Thus, according to the present invention, whether the misfire occurred or not is determined based on the temperature detected by the temperature sensor 10 which uses the sensor element 16 having a high heat-resistivity. Therefore, the misfire is surely detected without providing a complex structure for insulating heat.

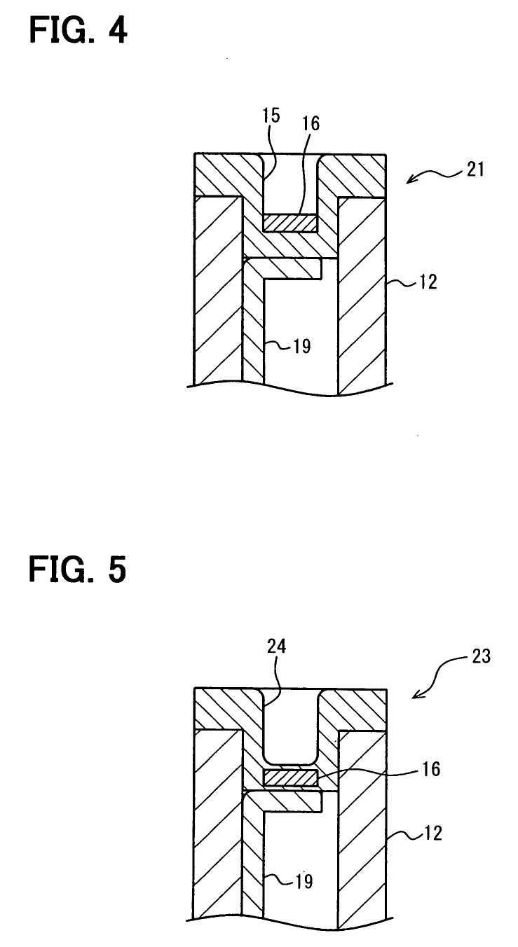

A second embodiment of the present invention is shown in FIG. 4. In this embodiment, the sensor element 16 is mounted on the front surface of the diaphragm 15 and the conductor element 19 is electrically connected to the sensor element 16 through the diaphragm 15. Other structures and functions are the same as those of the first embodiment. The sensor element 16 is directly exposed to the mixture gas in the combustion chamber 1, and the temperature in the combustion chamber is accurately detected.

A third embodiment of the present invention is shown in FIG. 5. In this embodiment, the sensor element 16 is disposed in the bottom wall of the diaphragm in such a manner that the sensor element 16 is sandwiched between thin upper and lower walls. In other words, the sensor element 16 is embedded in the bottom wall of the diaphragm 15. Other structures and functions are the same as those of the first embodiment. In this embodiment, the sensor element 16 is not directly exposed to the mixture in the combustion chamber 1.

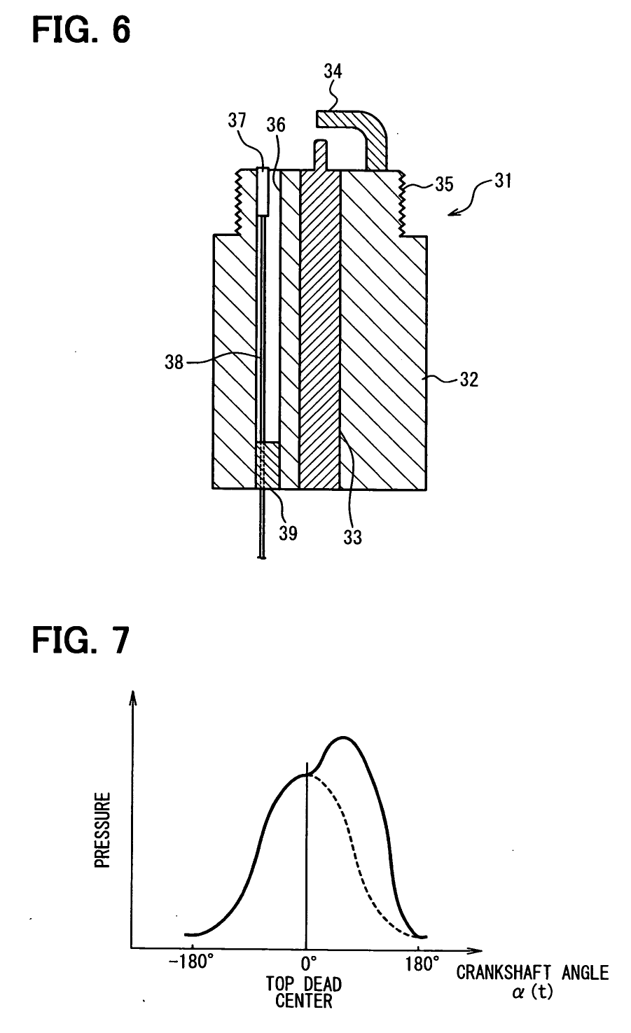

A fourth embodiment of the present invention is shown in FIG. 6. In this embodiment, the temperature sensor 31 is integrally formed with a spark plug. The spark plug includes a insulator 32 made of ceramics, a center electrode 33 held in the insulator, and a ground electrode 34 facing the center electrode 33, forming a spark gap therebetween. A screw 35 for connecting the spark plug to an engine is formed on a shell covering a tip of the insulator 32 (details are not shown). A probe portion 36 having an elongated inner space is provided in the insulator 32 in parallel to the center electrode 33. A sensor element 37 composed of an element such as a thin film thermistor is disposed at the tip of the probe portion 36, as shown in FIG. 6. The sensor element 37 is electrically connected to a processing circuit (not shown) contained in a connector housing (not shown) disposed at a bottom end of the insulator 32 through a conductor member 38. The conductor member 38 is hermetically sealed with a seal member 39 disposed at a bottom end of the probe portion 36. Since the temperature sensor is integrally formed with the spark plug that is essential to all the engines, no space for the temperature sensor is required.

The present invention is not limited to the embodiments described above, but it may be variously modified. For example, the sensor element 16, 37 may be composed of other elements than the thin film thermistor. For example, the sensor element may be composed of a thermocouple made of fine iridium coated with heat-resistive ceramics. Similar advantages are attained in this sensor element, too. Though the temperature sensor is mounted on each cylinder of the engine in the foregoing embodiment, one or more temperature sensors may be selectively installed in a cylinder or cylinders. The conductor member formed on flexible substrate, which is used in the foregoing embodiments, may be replaced with lead wires or other conductors.

While the present invention has been shown and described with reference to the foregoing preferred embodiments, it will be apparent to those skilled in the art that changes in form and detail may be made therein without departing from the scope of the invention as defined in the appended claims.

What is claimed is:

1. A temperature sensor for detecting temperature in a combustion chamber of an internal combustion engine, the temperature sensor comprising:
a housing mounted on a cylinder block or a cylinder head of the internal combustion engine;
an elongated cylindrical probe portion extending from the housing toward the combustion chamber of the engine so that a tip of the probe portion is exposed to the combustion chamber;
a diaphragm connected to the tip of the probe portion;
a sensor element connected to a front surface or a rear surface of the diaphragm;
a connector portion fixed to the housing for electrically connecting the sensor element to an outside device; and
a conductor member electrically connecting the sensor element to the connector portion, the conductor member being led through an inner space of the elongated cylindrical probe portion.

2. A temperature sensor for detecting temperature in a combustion chamber of an internal combustion engine, the temperature sensor comprising:
a housing mounted on a cylinder block or a cylinder head of the internal combustion engine;
an elongated cylindrical probe portion extending from the housing toward the combustion chamber of the engine so that a tip of the probe portion is exposed to the combustion chamber;
a diaphragm connected to the tip of the probe portion;
a sensor element embedded in the diaphragm;
a connector portion fixed to the housing for electrically connecting the sensor element to an outside device; and
a conductor member electrically connecting the sensor element to the connector portion, the conductor member being led through an inner space of the elongated cylindrical probe portion.

3. The temperature sensor as in claim 1, wherein the probe portion is integrally formed in a spark plug mounted on the engine, thereby eliminating the housing.

4. The temperature sensor as in claim 1, wherein the temperature sensor is mounted on each cylinder of the internal combustion engine having multi-cylinders.

5. The temperature sensor as in claim 1, wherein the sensor element is composed of a thermocouple coated with a heat-resistive material.

6. The temperature sensor as in claim 1, wherein the sensor element is composed of a thin film thermistor.

7. The temperature sensor as in claim 2, wherein the probe portion is integrally formed in a spark plug mounted on the engine, thereby eliminating the housing.

8. The temperature sensor as in claim 2, wherein the temperature sensor is mounted on each cylinder of the internal combustion engine having multi-cylinders.

9. The temperature sensor as in claim 2, wherein the sensor element is composed of a thermocouple coated with a heat-resistive material.

10. The temperature sensor as in claim 2, wherein the sensor element is composed of a thin film thermistor.
